(19) United States
(12) Patent Application Publication
(10) Pub. No.: US 2009/0273955 A1
(43) Pub. Date: Nov. 5, 2009

(54) OPTIMUM STRUCTURE FOR CHARGE PUMP CIRCUIT WITH BIPOLAR OUTPUT

(76) Inventors: Tang-Kuei Tseng, Jhudong Township (TW); Ryan Hsin-Chin Jiang, Taipei City (TW)

Correspondence Address: SINORICA, LLC, 2275 Research Blvd., Suite 500, ROCKVILLE, MD, 20850, US

(21) Appl. No.: 12/113,266

(22) Filed: May 1, 2008

(51) Int. Cl. H02M 3/07

(52) U.S. Cl. 363/60

(57) ABSTRACT

A charge pump circuit with bipolar output comprises a first switch capable of selectively connecting a first input terminal of a transfer capacitor to a voltage source, a second switch capable of selectively connecting a first input terminal of a first storage capacitor to said first input terminal of said transfer capacitor; a third switch capable of selectively connecting a second input terminal of said transfer capacitor to said voltage source; a fourth switch selectively connecting said second input terminal of said transfer capacitor to a ground terminal; and a fifth switch selectively connecting said second input terminal of said transfer capacitor to a second input terminal of a second storage capacitor. The charge pump circuit is collocated with clock signals to be selectively driven by a four-phase signal so as to produce bipolar voltages with magnitudes higher than the input voltage with minimum number of switches and capacitors and also accomplish the highest efficiency.

### BACKGROUND OF THE INVENTION

1. Field of the Invention

The present invention relates to a charge pump and, more particularly, to a charge pump circuit with bipolar output that includes minimum number of capacitors and switches and can be applied to existent CMOS IC fabrication processes.

2. Description of Related Art

With the development of the manufacturing process, the size and operating voltage of components become smaller. However, the transmission voltages of I/O signals usually are higher than those of internal circuits or applied voltages. Therefore, it is necessary to design a DC voltage conversion circuit in an IC to provide a voltage source with a voltage higher than the applied voltage. Charge pump circuit is one of the DC voltage conversion circuit.

Because the charge pump circuits proposed here have the function of converting a unipolar voltage (+V) to a bipolar voltage output (+/−V) or a bipolar double voltage output (+/−2V), they can be widely used in ICs, e.g., RS-232 ICs. U.S. Pat. No. 5,306,954 proposed by Sipex Corporation, USA discloses a charge pump circuit with symmetric positive/negative voltage output capability, which is composed of two transfer capacitors, two storage capacitors, and nine switches. The operation of these switches adopts clock signals generated by means of oscillation triggering to drive four-phase switching. Moreover, U.S. Pat. No. 4,999,761 proposed by Maxim Integrated Products, USA discloses an integrated bipolar charge pump power supply and an RS-232 transmitter/receiver, in which a charge pump circuit is composed of two transfer capacitors, two storage capacitors, and eight switches. These switches are driven by two-phase clock signals.

Regardless of what type of charge pump circuits mentioned above, they have the drawbacks of both limited charge conversion efficiency and large ripple of output voltage. In particular, the four-phase switched charge pump circuit proposed by Sipex Corporation, USA has a larger ripple. Moreover, the above-mentioned charge pump circuits include too many capacitors and switches, which increase the total cost and waste the precious design area. Therefore, a charge pump circuit with structure of small size and high efficiency has been proposed here.

Accordingly, the present invention aims to propose a new charge pump circuit structure with minimum number of capacitors and switches in order to solve the above problems in the prior art and create a high-efficiency circuit.

### SUMMARY OF THE INVENTION

An object of the present invention is to provide a charge pump circuit with bipolar output, which comprises minimum number switches and capacitors, and driven with four-phase clock. The proposed new charge pump circuit provides higher bipolar voltage than single power source input diminish the total cost and save huge design area in an IC, which meets the requirement for several high voltages application in an IC or I/O interface.

Another object of the present invention is to provide a charge pump circuit with bipolar output, which has the advantages of both high conversion efficiency and smaller ripple of output voltage.

To achieve the above objects, the present invention proposes a new charge pump circuit, which can produce bipolar voltage output based on a single input voltage. This charge pump circuit includes five switches: a first switch, a second switch, a third switch, a fourth switch, and a fifth switch. The first switch selectively connects a first input terminal of a transfer capacitor to a voltage source. The second switch selectively connects a first input terminal of a first storage capacitor to the first input terminal of the transfer capacitor. The third switch selectively connects a second input terminal of the transfer capacitor to the voltage source. The fourth switch selectively connects the second input terminal of the transfer capacitor to a ground terminal. The fifth switch selectively connects the second input terminal of the transfer capacitor to a second input terminal of a second storage capacitor. These five switches can perform four-phase switching based on clock signals to selectively store charges in the transfer capacitor, the first storage capacitor, and the second storage capacitor so as to provide bipolar voltage output for integrated IC product.

### BRIEF DESCRIPTION OF THE DRAWINGS

The various objects and advantages of the present invention will be more readily understood from the following detailed description when read in conjunction with the appended drawing, in which:

FIG. 1 is a diagram of a charge pump circuit of the present invention;

FIG. 2 is a timing diagram of four-phase control signals used in the circuit of the present invention; and

FIGS. 3(a) to 3(d) are functional diagrams under four phases operation in FIG. 1, respectively.

### DETAILED DESCRIPTION OF THE PREFERRED EMBODIMENTS

The present invention discloses a charge pump circuit with bipolar output, which includes minimum capacitors and switches and can apply to the present CMOS IC process. This charge pump circuit is composed of five switches, three capacitors and a power source, and makes use of four-phase clock signals to produce bipolar voltage higher than the input voltage. The proposed charge pump circuit meets the requirement that several high voltages for circuits in an IC or I/O circuits of an IC needed under the condition of a single power source.

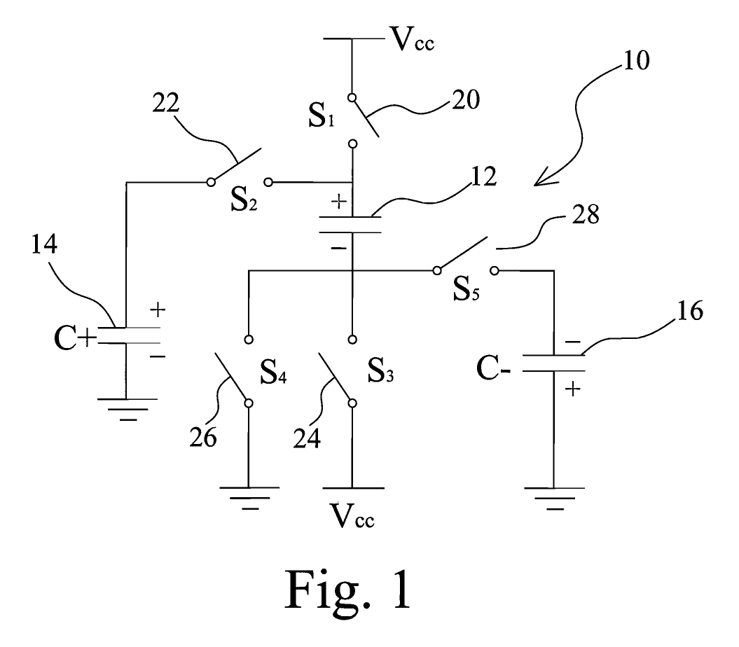

Please refer to FIG. 1. FIG. 1 is a diagram of a charge pump circuit of the present invention. As shown in FIG. 1, a charge pump circuit 10 comprises one transfer capacitor 12(C1), two storage capacitors 14 (C+) and 16 (C−), and five switches 20, 22, 24, 26, 28 (S1˜S5), and provides an input voltage collocated with clock signals to control the turn-on time of the switches in order to adjust the level of the output voltage and thus produce bipolar voltage output. The switch 20 selectively connects the voltage source (Vcc) to the first input terminal (+) of the transfer capacitor 12 (C1). The switch 22 selectively connects the first input terminal (+) of the transfer capacitor 12 (C1) to the first input terminal (+) of the first storage capacitor 14 (C+). The switch 24 selectively connects the second input terminal (−) of the transfer capacitor 12 (C1) to the voltage source (Vcc). The switch 26 selectively connects the second input terminal (−) of the transfer capacitor 12 (C1) to the ground terminal (Gnd). The switch 28 selectively connects the second input terminal (−) of the transfer capacitor 12 (C1) to the second input terminal (−) of the second storage capacitor 16 (C−). Moreover, the second input terminal (−) of the first storage capacitor 14 (C+) and the first input terminal (+) of the second storage capacitor 16 (C−) are connected to the ground terminal (Gnd).

Please note that, all of the switches 20, 22, 24, 26, and 28 can be realized with semiconductor transistors or bipolar junction transistors (BJTs), e.g., p-type MOS transistors, n-type MOS transistors, or npn or pnp transistors. Moreover, the above ground terminal can be the input of a different voltage source.

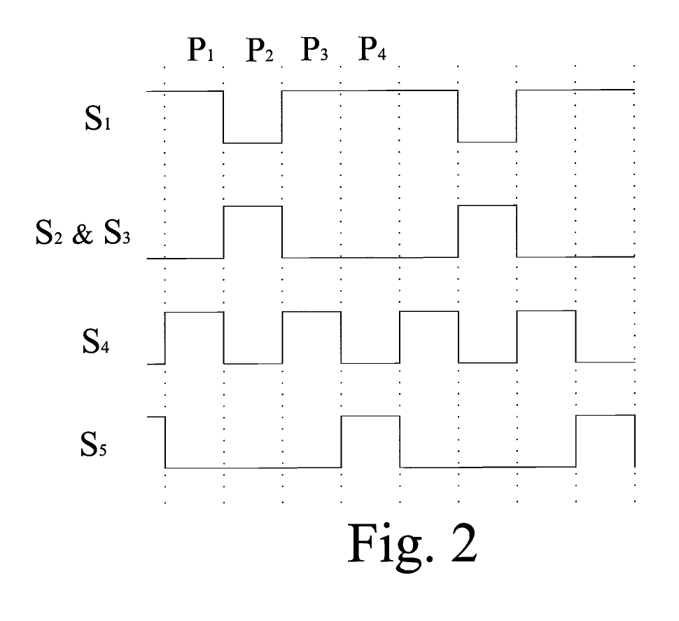

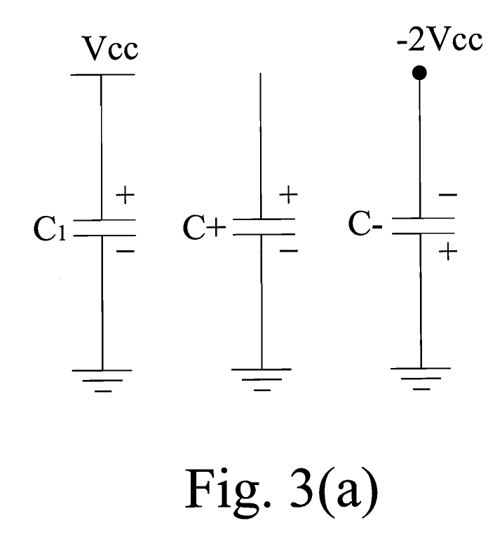

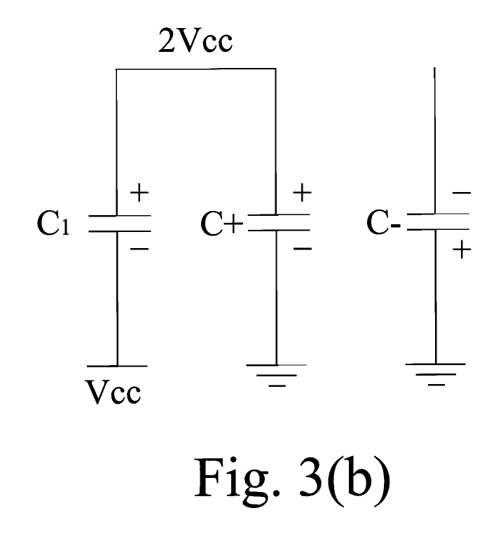

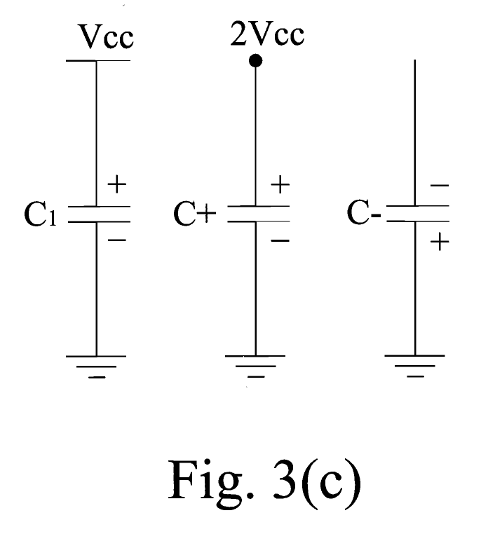

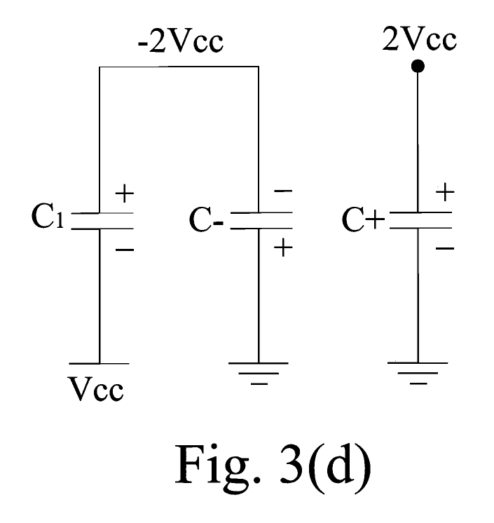

The actions of the switches 20, 22, 24, 26, and 28 are controlled by four phase clock signals generated by a clock generator (not shown). FIG. 2 is a timing diagram of four-phase control signals used in the circuit of the present invention. Please refer to FIG. 1 as well as FIG. 2. First, at the first phase (P1), the switch 20 (S1) and the switch 26 (S4) are enabled while the switch 22(S2), the switch 24 (S3), and the switch 28 (S5) are disabled. That is, at the first phase (P1), the first input terminal (+) of the transfer capacitor 12 (C1) is connected to the voltage source (Vcc) and the second input terminal (−) of the transfer capacitor 12 (C1) is connected to the ground terminal (Gnd). Under ideal conditions, assume the on-resistance of these switches is zero. When the voltage source Vcc charges the transfer capacitor 12 (C1), the voltage on the transfer capacitor 12 (C1) is Vcc, as shown in FIG. 3(a). Next, at the second phase (P2), the switch 20 (S1), the switch 26 (S4), and the switch 28 (S5) are disabled while the switch 22 (S2) and the switch 24 (S3) are enabled to be on state. Please note that, in the present invention, the switch 22 (S2) and the switch 24 (S3) have the same clock signal. At the second phase (P2), the first input terminal (+) of the first storage capacitor 14 (C+) is connected to the first input terminal (+) of the transfer capacitor 12 (C1), and the second input terminal (−) of the transfer capacitor 12 (C1) is connected to the voltage source Vcc. Accordingly, the voltage source Vcc is applied on the second input terminal (−) of the transfer capacitor 12 (C1) to produce a voltage of 2Vcc at the first input terminal (+) of the transfer capacitor 12 (C1), and charge sharing is then happened with the first storage capacitor 14 (C+), as shown in FIG. 3(b). That is, the positive double voltage (2Vcc) can be produced at this second phase (P2) after several clock cycle in ideal case.

At the third phase (P3), the switch 22 (S2), 24 (S3), and 28 (S5) are disabled while the switch 20 (S1) and the switch 26 (S4) are enabled to be on state. At this time, the transfer capacitor 12 (C1) is reconnected to the voltage source (Vcc) and the ground terminal (Gnd). The voltage source Vcc charges the transfer capacitor 12 (C1) to a voltage of Vcc again, as shown in FIG. 3(c). Finally, at the fourth phase (P4), the switch 22 (S2), 24 (S3) and 26 (S4) are disabled while the switch 20 (S1) and the switch 28 (S5) are enabled to be on state. At this time, the second input terminal (−) of the second storage capacitor 16 (C−) is connected to the second input terminal (−) of the transfer capacitor 12 (C1), and the first input terminal (+) of the transfer capacitor 12 (C1) is connected to the voltage source Vcc. Accordingly, the voltage source Vcc is applied on the first input terminal (+) of the transfer capacitor 12 (C1) to produce a voltage of −2Vcc at the second input terminal (−) of the transfer capacitor 12 (C1), and charge sharing is then happened with the second storage capacitor 16 (C−), as shown in FIG. 3(d). That is, the negative double voltage (−2Vcc) can be produced at this fourth phase (P4) after several clock cycle in ideal case.

As mentioned above, the charge pump circuit 10 could generate the positive double voltage (2Vcc) at the second phase (P2) and the negative double voltage (−2Vcc) at the fourth phase (P4). However, the phase control is not limited to the above description. That is, in other embodiments, the different phase can be assigned by different conditions depending on design requirements. For example, at the second phase (P2), the switch 22 (S2), 24 (S3) and 26 (S4) can be disabled while the switch 20 (S1) and the switch 28 (S5) are enabled to be on state, and at the four phase (P4), the switch 20 (S1) and switch 26 (S4) can be disabled while the switch 22 (S2) and the switch 24 (S3) are enabled to be on state. In this situation, the charge pump circuit 10 could generate the negative double voltage (−2Vcc) at the second phase (P2) and the positive double voltage (2Vcc) at the fourth phase (P4).

In contrast to the related charge pump circuit, the present invention proposes a high-efficiency charge pump circuit with minimum electronic devices (e.g. switches and capacitors). The charge pump circuit in the present invention includes only three capacitors and five switches to output the bipolar voltages under four-phase driven, which diminishes the total cost and saves huge design area in IC. Moreover, the present invention has high performance and low cost design. Therefore, the present invention has many economic benefits.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A charge pump circuit with bipolar output producing bipolar output voltages based on an input voltage, said charge pump circuit comprising:
a first switch selectively connecting a first input terminal of a transfer capacitor to a voltage source;
a second switch selectively connecting a first input terminal of a first storage capacitor to said first input terminal of said transfer capacitor;
a third switch selectively connecting a second input terminal of said transfer capacitor to said voltage source;
a fourth switch selectively connecting said second input terminal of said transfer capacitor to a ground terminal; and
a fifth switch selectively connecting said second input terminal of said transfer capacitor to a second input terminal of a second storage capacitor.

2. The charge pump circuit with bipolar output as claimed in claim 1, wherein a second input terminal of said first storage capacitor connects to said ground terminal.

3. The charge pump circuit with bipolar output as claimed in claim 1, wherein a first input terminal of said second storage capacitor connects to said ground terminal.

4. The charge pump circuit with bipolar output as claimed in claim 1, wherein all of said first switch, said second switch, said third switch, said fourth switch, and said fifth switch are composed of semiconductor transistors or bipolar junction transistors (BJTs).

5. The charge pump circuit with bipolar output as claimed in claim 1 further comprising a clock generator, wherein said clock generator produces a plurality of clock signals to control actions of said first switch, said second switch, said third switch, said fourth switch, and said fifth switch, respectively.

6. The charge pump circuit with bipolar output as claimed in claim 5, wherein said first switch, said second switch, said third switch, said fourth switch, and said fifth switch are controlled by four-phase switching.

7. The charge pump circuit with bipolar output as claimed in claim 6, wherein actions of said first switch, said second switch, said third switch, said fourth switch, and said fifth switch comprise the steps of:
at a first phase, enabling said first switch and said fourth switch, and disabling said second switch, said third switch and said fifth switch to let said voltage source (Vcc) charge said transfer capacitor;
at a second phase, enabling said second switch and said third switch, and disabling said first switch, said fourth switch and said fifth switch to let said voltage source (Vcc) act on said transfer capacitor and said first storage capacitor;
at a third phase, enabling said first switch and said fourth switch, and disabling said second switch, said third switch and said fifth switch to let said voltage source (Vcc) charge said transfer capacitor; and
at a fourth phase, enabling said first switch and said fifth switch, and disabling said second switch, said third switch and said fourth switch to let said voltage source (Vcc) act on said transfer capacitor and said second storage capacitor.

8. The charge pump circuit with bipolar output as claimed in claim 6, wherein actions of said first switch, said second switch, said third switch, said fourth switch, and said fifth switch comprise the steps of:
at a first phase, enabling said first switch and said fourth switch, and disabling said second switch, said third switch and said fifth switch to let said voltage source (Vcc) charge said transfer capacitor;
at a second phase, enabling said first switch and said fifth switch, and disabling said second switch, said third switch and said fourth switch to let said voltage source (Vcc) act on said transfer capacitor and said second storage capacitor;
at a third phase, enabling said first switch and said fourth switch, and disabling said second switch, said third switch and said fifth switch to let said voltage source (Vcc) charge said transfer capacitor; and
at a fourth phase, enabling said second switch and said third switch, and disabling said first switch, said fourth switch and said fifth switch to let said voltage source (Vcc) act on said transfer capacitor and said first storage capacitor.

9. The charge pump circuit with bipolar output as claimed in claim 6, wherein said second switch and said third switch have same clock signal.

10. The charge pump circuit with bipolar output as claimed in claim 1, wherein the output voltage of said charge pump circuit is controlled between |Vccl and 2|Vccl and up to 2|Vccl by controlling a turn-on time of said first switch, said second switch, said third switch, said fourth switch and said fifth switch.

11. The charge pump circuit with bipolar output as claimed in claim 1, wherein said ground terminal is further connected to another voltage source.

12. The charge pump circuit with bipolar output as claimed in claim 1, wherein said first input terminal of said transfer capacitor, said first input terminal of said first storage capacitor, and said first input terminal of said second storage capacitor are positive electrode terminals.

13. The charge pump circuit with bipolar output as claimed in claim 1, wherein said second input terminal of said transfer capacitor, said second input terminal of said first storage capacitor, and said second input terminal of said second storage capacitor are negative electrode terminals.
